(19) United States
(12) Patent Application Publication
(10) Pub. No.: US 2009/0073297 A1
(43) Pub. Date: Mar. 19, 2009

(54) TWISTED INPUT PAIR OF FIRST GAIN STAGE FOR HIGH SIGNAL INTEGRITY IN CMOS IMAGE SENSOR

(75) Inventors: Taehee Cho, Irvine, CA (US); Jeffrey Gleason, Boise, ID (US); Espen Olsen, Irvine, CA (US); Kwang-bo (Austin) Cho, Valencia, CA (US); Suat Utku Ay, Pasadena, CA (US)

Correspondence Address: RatnerPrestia, P.O. BOX 980, VALLEY FORGE, PA, 19482, US

(73) Assignee: Micron Technology, Inc., Boise, ID (US)

(21) Appl. No.: 11/856,296

(22) Filed: Sep. 17, 2007

(51) Int. Cl. H04N 3/14; H01L 21/44

(52) U.S. Cl. 348/308; 438/652; 257/E21.476; 348/E03.016

(57) ABSTRACT

Methods for forming conductors and global bus configurations for reducing an interference signal from electromagnetic interference (EMI) source are provided. First and second conductor lines are formed on an integrated circuit in a twisted pair configuration. A differential amplifier is formed on the integrated circuit and coupled to each of the first and second conductor lines. The first and second signals are respectively transmitted through the first and second conductor lines and are modified by the interference signal. The modified first and second signals are differentially amplified by the differential amplifier so that the interference signal is substantially cancelled.

### FIELD OF THE INVENTION

The present invention relates to CMOS imagers, in particularly, methods for reducing an interference signal to a global bus and a fabrication of a global bus of a CMOS image sensor.

### BACKGROUND OF THE INVENTION

Image sensors find applications in a wide variety of fields, including machine vision, robotics, guidance and navigation, automotive applications and consumer products. In many smart image sensors, it is desirable to integrate on chip circuitry to control the image sensor and to perform signal and image processing on the output image. Charge-coupled devices (CCDs), which have been one of the dominant technologies used for image sensors, however, do not easily lend themselves to large scale signal processing and are not easily integrated with complimentary metal oxide semiconductor (CMOS) circuits.

CMOS image sensors are increasing being developed to handle applications having increased frame rates. In order to provide an increased frame rate, CMOS image sensors typically use a multi-channel read out of pixels of the image sensor. The multi-channel readout may be used to increase the frame rate, even with limitations in an amplifier speed of a gain stage and a speed of an analog-to-digital (ADC) conversion stage of the CMOS image sensor. Different channels of image sensor may be susceptible to different levels of electromagnetic interference (EMI) from an EMI source, such as another signal line on the image sensor. Because a multi-channel readout is used, any asymmetrical differential coupling among the channels of the CMOS image sensor may produce a channel mismatch into the ADC conversion stage. The resulting digitized image may include a column fixed pattern noise (FPN).

### BRIEF DESCRIPTION OF THE DRAWINGS

The invention is best understood from the following detailed description when read in connection with the accompanied drawing. Included in the drawing are the following figures:

FIG. 1 is a block diagram illustrating a CMOS image sensor system;

FIG. 2 is a circuit diagram illustrating a global bus between column sample and hold (S/H) circuitry and amplifier circuitry of the CMOS image sensor of FIG. 1;

FIG. 3A is a block diagram illustrating conductor layout including a global bus;

FIG. 3B is a cross section diagram along line A-A′ illustrating parasitic capacitance coupled to the global bus due to the conductor layout shown in FIG. 3A;

FIG. 3C is a circuit diagram of the amplifier circuitry during column readout, including the parasitic capacitance shown in FIG. 3B;

FIG. 3D is a circuit diagram illustrating one channel of a global bus and different parasitic capacitances that may be coupled to the global bus;

FIG. 4A is a block diagram of a conductor layout including a global bus configuration according to an embodiment of the present invention;

FIGS. 4B and 4C are cross section diagrams illustrating a parasitic capacitance coupled to the global bus due to the conductor layout shown in FIG. 4A, along respective lines A-A′ and B-B′;

FIG. 4D is a circuit diagram of the amplifier circuitry during column readout, including the parasitic capacitance shown in FIGS. 4B and 4C;

FIG. 5 is a block diagram of a conductor layout including a global bus configuration according to another embodiment of the present invention;

FIG. 6A is an overhead view illustrating a portion of a global bus configuration;

FIG. 6B is a cross section of the global bus configuration shown in FIG. 6A along line A-A′;

FIG. 7A is an overhead view of a portion of a global bus configuration according to an embodiment of the present invention;

FIG. 7B is an exploded overhead view of the portion of the global bus shown in FIG. 7A, illustrating a twist in a portion of the signal and reset busses;

FIGS. 7C, 7D and 7E are cross sectional diagrams of the global bus configuration shown in FIG. 7A, along respective lines A-A′, B-B′ and C-C′;

FIG. 8A is an overhead view of a global bus formed from a number of the signal and reset bus twists shown in FIG. 7A, according to an embodiment of the present invention;

FIG. 8B is an exploded overhead view of the global bus shown in FIG. 8A;

FIG. 9A is a cross section diagram of the global bus configuration shown in FIG. 6A, along line A-A′, illustrating an example of width dimensions of the global bus;

FIG. 9B is a cross section diagram of the global bus configuration shown in FIG. 7A along line C-C′, illustrating an example of width dimensions of the global bus, according to an embodiment of the present invention;

FIG. 9C is a cross section diagram with respect to a length of the global bus configuration shown in FIG. 6A;

FIG. 9D is a cross section diagram along a length of the global bus configuration shown in FIG. 8A, illustrating a twisted pair configuration, according to an embodiment of the invention;

FIG. 9E is a cross section diagram of the global bus configuration shown in FIG. 6A, illustrating various parasitic capacitances coupled to the global bus;

FIGS. 9F and 9G are cross section diagrams of the global bus along respective lines C-C′ and A-A′ illustrating various parasitic capacitances;

FIG. 10 is a flow chart illustrating a method for fabricating the global bus configuration shown in FIGS. 8A and 8B according to an embodiment of the present invention;

FIG. 11A is an overhead view diagram of a global bus configuration according to another embodiment of the present invention;

FIGS. 11B, 11C and 11D are cross section diagrams of the global bus shown in FIG. 11A along respective lines A-A′, B-B′, and C-C′;

FIG. 11E is a plane view of the global shown in FIG. 11 along conductive layer M3; and

FIG. 12 is a flow chart illustrating a method of fabricating the global bus shown in FIGS. 11A-11E according to another embodiment of the present invention.

### DETAILED DESCRIPTION OF THE INVENTION

In the following detailed description, reference is made to the accompanied drawings which form a part hereof, and which illustrates specific embodiments of the present invention. These embodiments are described in sufficient detail to enable those of ordinary skill in the art to make and use the invention. It is also understood that structural, logical or procedural changes may be made to the specific embodiment disclosed without departing from the scope of the present invention.

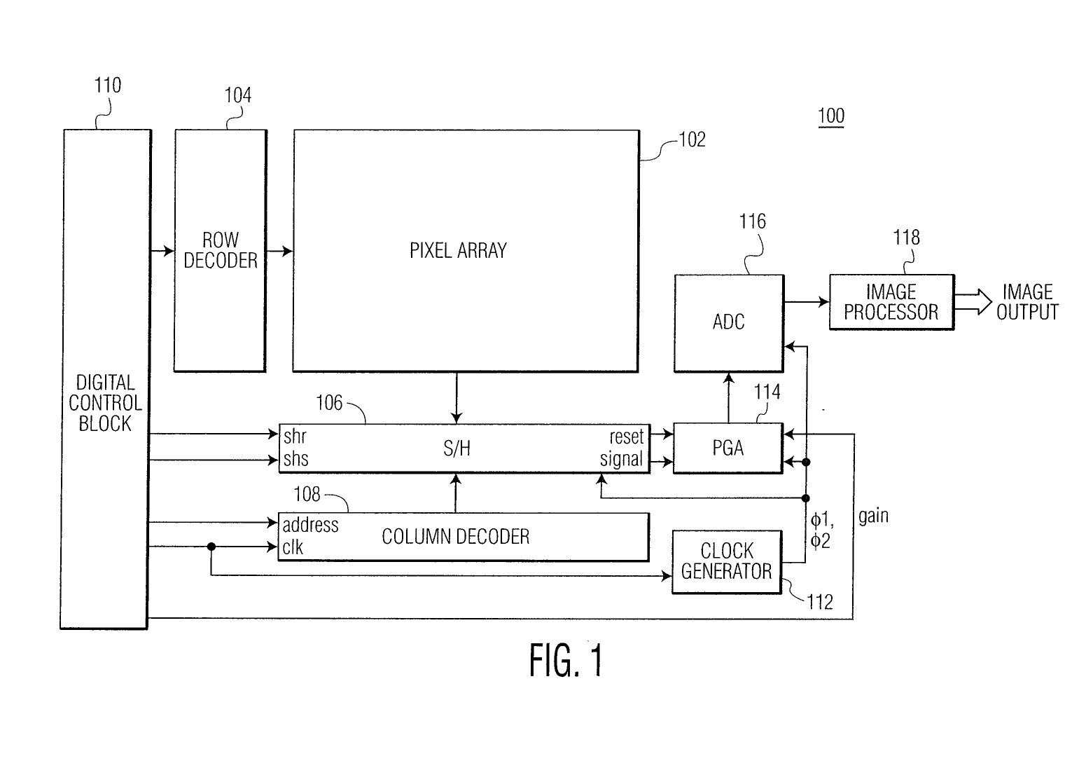

FIG. 1 is a block diagram of a CMOS image sensor 100 including pixel array 102. Pixel array 102 of image sensor 100 includes a plurality of pixels arranged in a predetermined number of columns and rows. The pixels of each row in the array are turned on at the same time by a row select line and the pixels of each column are selected for output by a column select line. A plurality of row and column lines are provided for the entire array.

The row lines are selectively activated by a row driver (not shown) in response to row address decoder 104 and the column select lines are selectively activated by a column driver (not shown) in response to column address decoder 108. Thus, a row and column address is provided for each pixel. CMOS image sensor 100 is operated by control circuit 110, which controls address decoders 104, 108 for selecting the appropriate row and column lines for pixel readout, and row and column driver circuitry, which apply driving voltages to the drive transistors of the selected row and column lines.

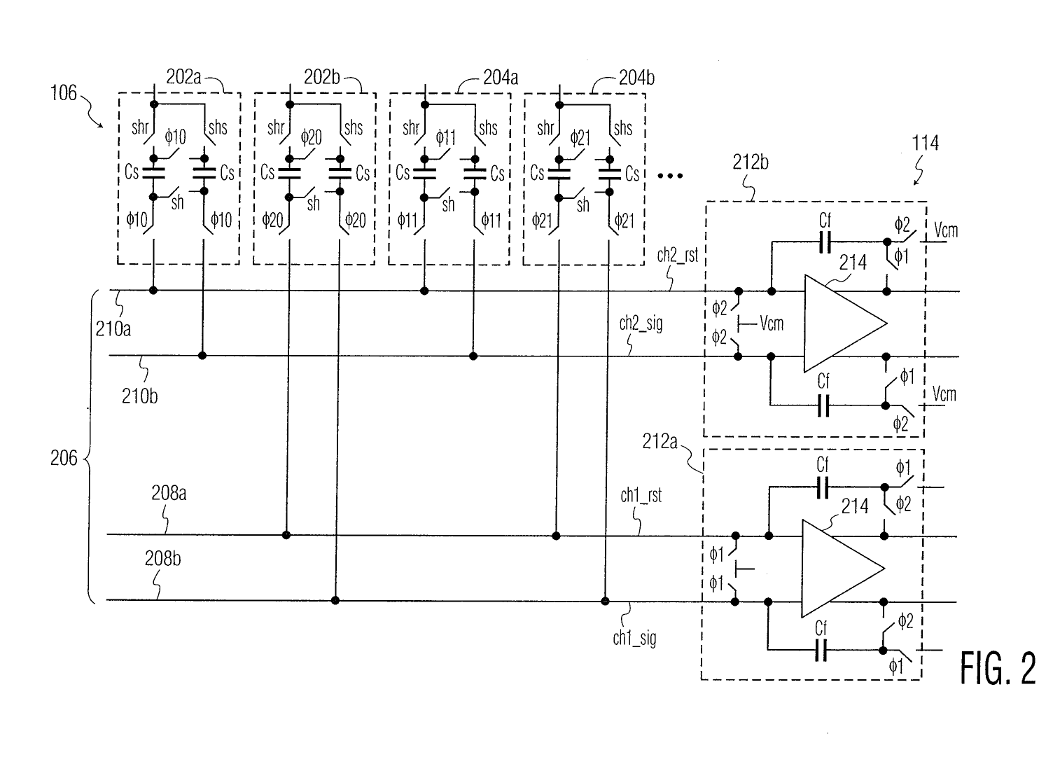

Each column of the array contains sample and hold circuitry (S/H), designated generally as 106, including sample and hold capacitors and switches associated with the column driver that read and store a pixel reset signal (i.e. reset) and a pixel image signal (i.e. signal) for selected pixels (described further with respect to FIG. 2). A differential signal (reset-signal) is produced by programmable gain amplifier (PGA) circuit 114 for each pixel, which is digitized by analog-to-digital converter 116 (ADC). ADC 116 supplies the digitized pixel signals to image processor 118, which forms and outputs a digital image.

Control circuit 110 also provides a gain, V_{cm}, to PGA 114 and controls clock generator 112, which applies clock signals φ1, φ2 to PGA circuit 114 for controlling a reset and column readout of pixels by PGA 114.

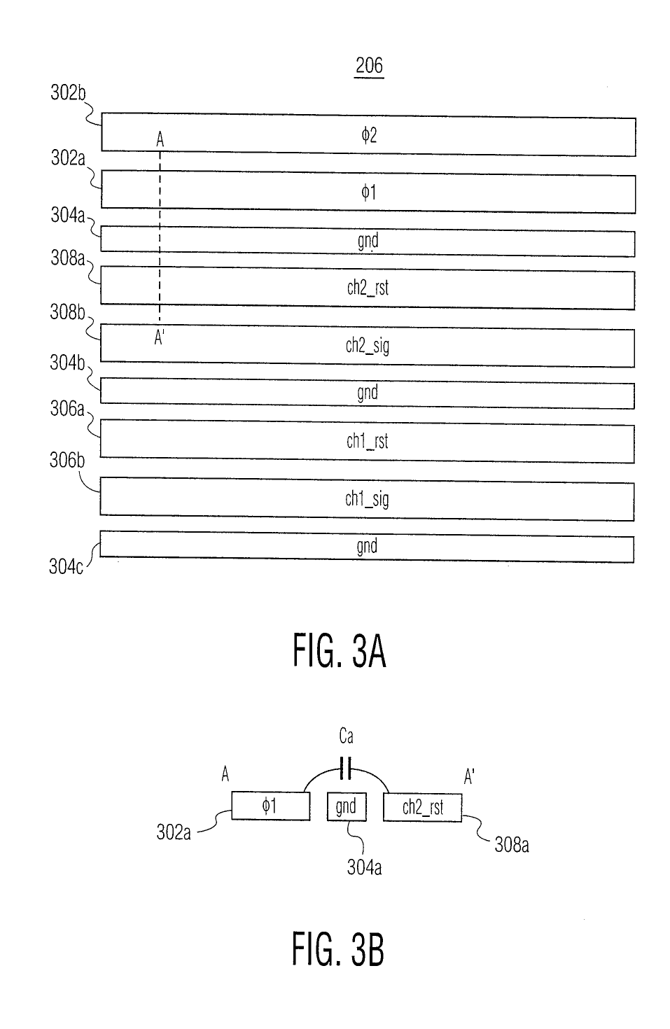

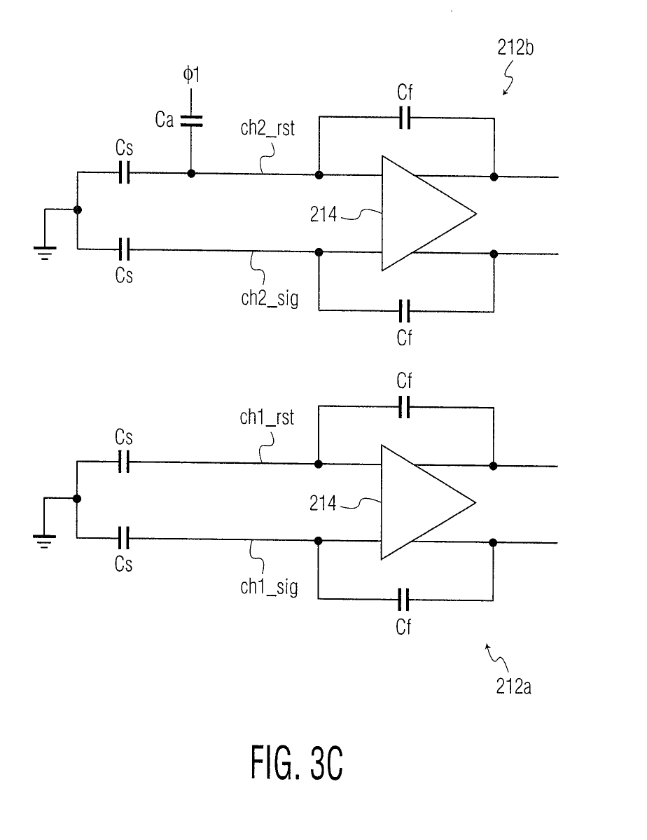

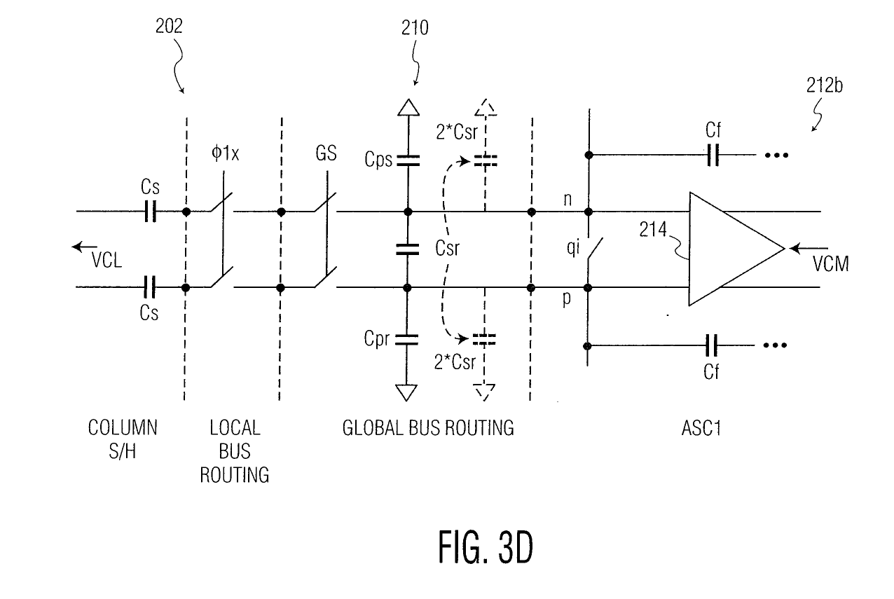

FIG. 2 is a circuit diagram illustrating a portion of S/H circuit 106, global bus 206 and PGA 114. S/H circuit 106 includes column S/H circuits 202 and 204 corresponding to respective even and odd rows. For example, if color filters included on pixel array 102 (FIG. 1) are arranged in a Bayer pattern, S/H circuits 202a and 202b may store reset and image signals corresponding to respective red and green pixels of an even row. In addition, column S/H circuits 204a, 204b may store reset and image signals corresponding to blue and green pixels of an odd row. Group switches (GS) (FIG. 3D) may be used select the rows (i.e. corresponding to column S/H circuits 202 or 204), and the reset signals (chx_rst) and image signals (chx_sig) for channels x=1,2 are provided to global bus 206.

Each column S/H circuit 202, 204 includes switches sample reset (SHR) and sample pixel (SHS), used to perform a correlated double sampling (CDS) procedure in conjunction with switch sh. Column S/H circuits 202, 204 also include column select switches φ10, φ20, φ11 and φ22, associated with selection of the corresponding column. A reset signal and an image signal from the associated pixel are stored on respective capacitors Cs and provided to global bus 206 according to the column switch selection.

Global bus 206 includes first channel signal lines 208a, 208b coupled to amplifier circuit 212a and second channel signal lines 210a, 210b coupled to amplifier circuit 212b. Amplifier circuit 212b is the same as amplifier circuit 212a, except that amplifier circuit 212b receives channel 2 reset and image signals (i.e. ch2_rst and ch2_sig from column S/H circuits 202a, 204a), whereas amplifier circuit 212a receives channel 1 reset and image signals (i.e. ch1_rst and ch1_sig from column circuits 202b, 204b). Amplifier circuits 212 each includes a differential amplifier 214 and feedback capacitor (CF). Amplifier circuits 212 also receive gain Vcm, for example from control circuit 110 (FIG. 1). Responsive to clock signals φ1 and φ2 and gain Vcm, amplifier circuits 212 may be provided in a gain stage, as shown in FIG. 3C or in a reset stage (not shown).

The reset and image signal lines from the column S/H circuits 202, 204 are inputs to the amplifier circuits 212 and common to the entire column S/H circuitry shown in FIG. 2. Because the channel 1 signal lines 208 and channel 2 signal lines 210 are of high impedance, careful layout of the global bus 206 is desirable to prevent interference from various electromagnetic interference (EMI) sources. An EMI source may include, for example, a signal line placed near the global bus, such as a clock signal. A parasitic capacitance may be formed between the EMI source and a conductor of the global bus.

FIGS. 3A-3D illustrate a conductor layout that includes global bus 206. In particular, FIG. 3A is a block diagram illustrating the conductor layout; FIG. 3B is a cross section diagram along line A-A′ illustrating parasitic capacitance coupled to the global bus due to the conductor layout; FIG. 3C is a circuit diagram of the amplifier circuitry during column readout when the parasitic capacitance is included; and FIG. 3D is a circuit diagram illustrating one channel of global bus 206 and different parasitic capacitances that may be coupled to the global bus.

As shown in FIG. 3A, clock conductors 302a, 302b are formed relative to first channel conductors 306a, 306b and second channel conductors 308a, 308b of a global bus configuration. Clock conductors 302a and 302b carry respective clock signals φ1 and φ2. First channel conductors 306a, 306b correspond to channel 1 signal lines 208a, 208b and carry channel 1 reset and image signals, respectively. Second channel conductors 308a, 308b correspond to channel 1 signal lines 210a, 210b and carry channel 2 reset and image signals, respectively.

First channel conductors 306 are shielded from second channel conductors 304 and other signal conductors by grounded conductors 304b and 304c. Similarly, second channel conductors 308 are shielded from first channel conductors 306 and clock conductors 302 by the grounded conductors 304a and 304b.

Although the second channel conductors 308a, 308b and first channel conductors 306a and 306b may be shielded by the grounded conductors 304a-c, as the global bus conductors 306, 308 become longer, a fringe capacitance may be seen on the high impedance first channel conductor 308a, for example, from any signal lines, such as clock signal φ1 (via clock conductor 302a). Global bus 206, thus, may be susceptible to interfering sources, i.e. EMI sources even with shielding by ground conductors 304.

For example, FIG. 3B is a cross section diagram along line A-A′ from clock conductor line 302a through second channel conductor 308a that carries a channel 2 reset signal (ch2_rst). A parasitic capacitance Ca may be coupled between clock conductor 302a carrying φ1 and second channel conductor 308a.

As illustrated in the circuit diagram of FIG. 3C, when parasitic capacitance Ca is coupled to second channel conductor line 308a, an equivalent circuit for amplifier 212b includes clock signal φ1 coupled to amplifier circuit 212b via parasitic capacitance Ca.

For example, a parasitic capacitance Ca of about 1 aF/μm becomes about 1 fF for a 1,000 μm long column signal line. A channel 1 differential output from amplifier circuit 212a may be represented by Vo1=Cs/Cf (Vrst−Vsig). A differential output from Channel 2 (amplifier circuit 212b), in contrast, may be represented by Vo2=Cs/Cf (Vrst−Vsig) +Ca/Cf*(Vφ1). When Cf and φ1 are respectively 1 pF and 3 V, the channel mismatch between amplifier circuits 212a and 212b is about 1/1,000*3 V or about 3 mV. A 3 mV channel mismatch is equivalent to about 3 least significant bits (LSB) in 10 bit ADC and 12 times an LSB in 12 bit ADC at a PGA gain of x1. If the PGA gain is increased by x16, the mismatch may become about 48 times an LSB in 10 bit ADC and about 192 times an LSB in 12 bit ADC.

Because of parasitic capacitance, further shielding of the high impedance global bus signal lines 208, 210 decreases the feedback factor for the first gain stage of amplifier circuits 212 (FIG. 2). This may result in more power and greater layout area of the first gain stage of PGA 114. At the same time, the clock and column signal lines typically cannot be located farther from signal lines 208 and 210 because of the available size of the chip area for CMOS image sensor 100.

Although FIG. 3B illustrates a parasitic capacitance coupled to first channel conductor 304a that transmits a reset signal, in general, as shown in FIG. 3D, the global bus 206 may be susceptible to at least three different parasitic capacitances. Capacitance Cpr between a general EMI source and the reset line is similar to Ca shown in FIG. 3B. A second parasitic capacitance Cps may be coupled to a channel of the global bus between a further EMI source and the signal line. A third parasitic capacitance Csr may be coupled between the signal line and the reset line of a channel of the global bus. Typically, parasitic capacitances Cps and Cpr are minimized in order to optimize speed and power consumption by the amplifier circuit 212. Coupling capacitance Csr is typically nulled using a switch (not shown) on the amplifier circuit 212 site to set the inputs of the amplifier circuit 212 to a common mode voltage. However, the effects on the feedback factor of amplifier circuit 212 are more pronounced than the parasitic capacitances CPS and CPR.

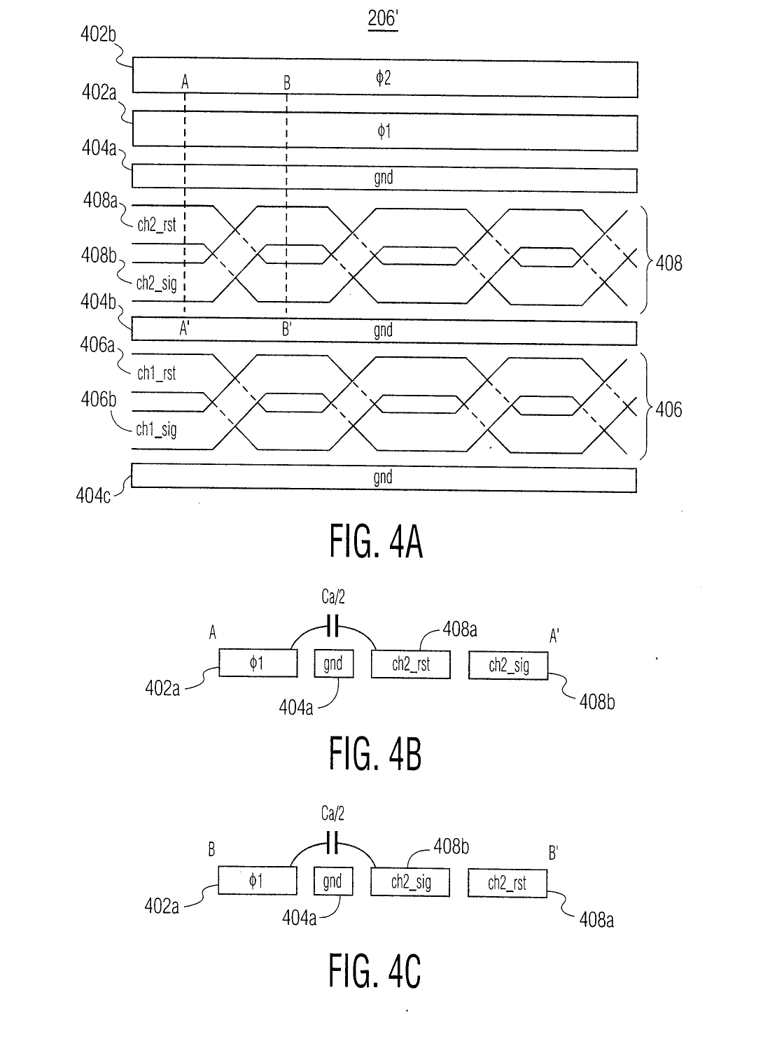

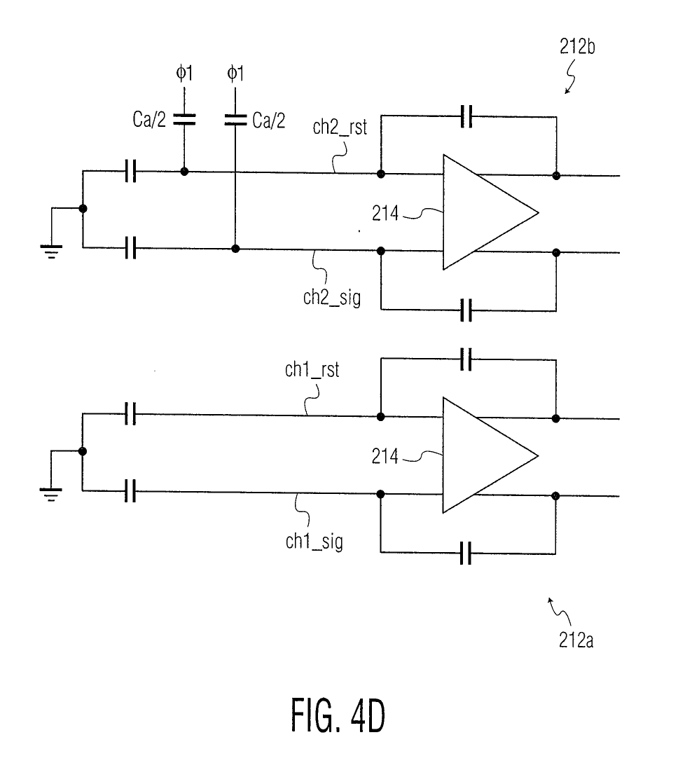

FIGS. 4A-4D illustrate global bus 206 having a twisted pair configuration, according to an embodiment of the present invention. In particular, FIG. 4A is a block diagram of a conductor layout including a twisted pair global bus configuration; FIG. 4B is a cross section diagram, taken along lines A-A′, illustrating a parasitic capacitance coupled to the signal line of the global bus; FIG. 4C is a cross section diagram, taken along lines B-B′, illustrating a parasitic capacitance coupled to the reset line of the global bus; and FIG. 4D is a circuit diagram of the amplifier circuitry during column readout, when the parasitic capacitances included in the twisted pair global bus are included.

As shown in FIG. 4A, a twisted pair configuration of conductors 406a, 406b of Channel 1 and of conductors 408a and 408b of Channel 2 define respective twisted pairs 406 and 408. Twisted pairs 406 and 408 are each shielded by respective grounded conductors 404a-404c. Clock conductors 402a, 402b, that respectively carry clock signals φ1 and φ2, are provided near twisted pair 408.

As shown in the cross section diagrams of FIGS. 4B and 4C, parasitic capacitance Ca/2 is coupled between clock conductor 402a and conductor 408a, that carries the channel 2 reset signal. Because conductors 408a, 408b are twisted, as shown in FIG. 4C, parasitic capacitance Ca/2 is also coupled between clock conductor 402a and conductor 408b, that carries the channel 2 image signal.

As shown in FIG. 4D, because of the twisted pair 408 configuration, the parasitic coupling due to clock signal φ1 is evenly distributed to the channel 2 reset and signal lines. Accordingly, when amplifier circuit 212b operates in differential mode, the differential output of channel 2 becomes Vo2=Cs/Cf*(Vrst−Vsig)+0.5*Ca/Cf*(Vφ1). An interference signal of one or more EMI sources may be substantially canceled by the common mode rejection of differential amplifier 214. Accordingly a channel mismatch between outputs of amplifiers 212a and 212b, may also be minimized.

A change of common mode input level is typically about 0.5 Ca/(Cp+0.5 Ca)*Vφ1 or approximately 1.5 mV, where Ca and Cp (i.e., a general parasitic capacitance) for example, may be about 1 fF and 1 pF, respectively. A common mode rejection of amplifier 212 is typically over 40 dB. In this example, 15 μV at the output of amplifier circuit 212 is provided. If the gain of amplifier circuit is x16, the final output becomes about 250 μV, which is about 0 LSB in both 10 bit and 12 bit ADC. Accordingly, a common mode rejection of amplifier circuit 212 may be suitable with a twisted pair configuration of global bus 206, to reduce the effects of EMI sources on the reset and image signals carried by global bus 206.

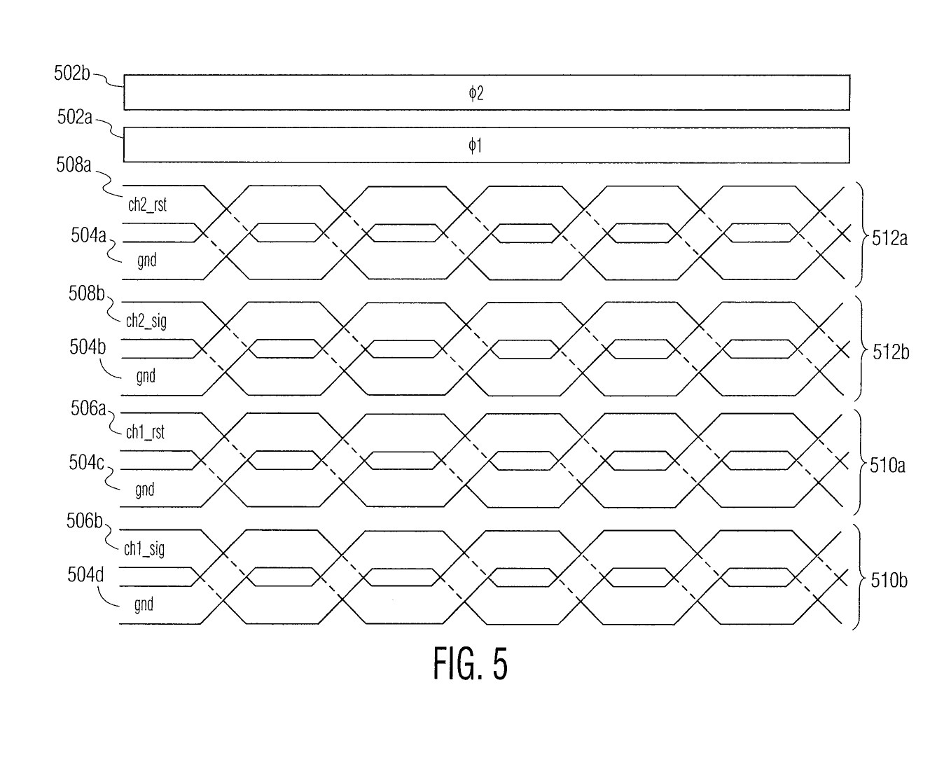

FIG. 5 is a block diagram of a conductor layout including another global bus configuration, according to another embodiment of the present invention. Each channel conductor 506, 508 of the global bus 206 is twisted with a corresponding ground conductor 504, that carries a ground signal. Channel 1 conductors 506a,b respectively carry the channel 1 reset and image signals and are twisted with ground conductors 504 to form respective twisted pairs 510a,b. Similarly, channel 2 conductors 508a,b respectively carry the channel 2 reset and image signals and are twisted with ground conductors 504 to form respective twisted pairs 512a,b. Clock conductors 502a,b respectively carry clock signals φ1 and φ2. Ground conductors 504 may be used to shield the conductor lines 506 and 508 of the two channels of global bus 206 that are provided to respective amplifier circuits 212a,b (FIG. 2).

As described above, each channel of global bus 206 may be formed from signal and reset conductors arranged as a twisted pair, in order to reduce EMI from external sources and crosstalk from neighboring wires. When the conductors are not twisted, in contrast, the two conductors may be exposed to different EMI. Twisting the conductors may decrease interference, because a loop area between the conductors (which determines the magnetic coupling into the signal) is typically reduced. Often, the two conductors carrying equal and opposite signals (i.e. in a differential mode) are combined by subtraction at the amplifier circuit 212 (FIG. 2). The noise signals from the two conductors typically cancel each other in the differential amplification because the two conductors are exposed to similar electromagnetic interference. Accordingly, the greater the number twists in the two conductors, the greater the attenuation of crosstalk.

Typically, in CMOS image sensors having a serial readout architecture, one or more global buses carries the differential pixel signals (i.e. signal and reset signals) that are sampled on the column S/H circuits 202, 204 to the amplifier 114 (FIG. 2). Columns are typically divided into small groups, for example typically 32 columns. The selected column is transferred onto a local bus and then to the global bus 206 (FIG. 2) through column select and group select switches. A column select, generated by a column decoder 108 (FIG. 1) is used to transfer addressed column signals onto the local bus. Column decoder 108 also generates a group select pulse used by the group switches (GS) to connect the local bus that contains the addressed columns to global bus 206 (FIG. 3D).

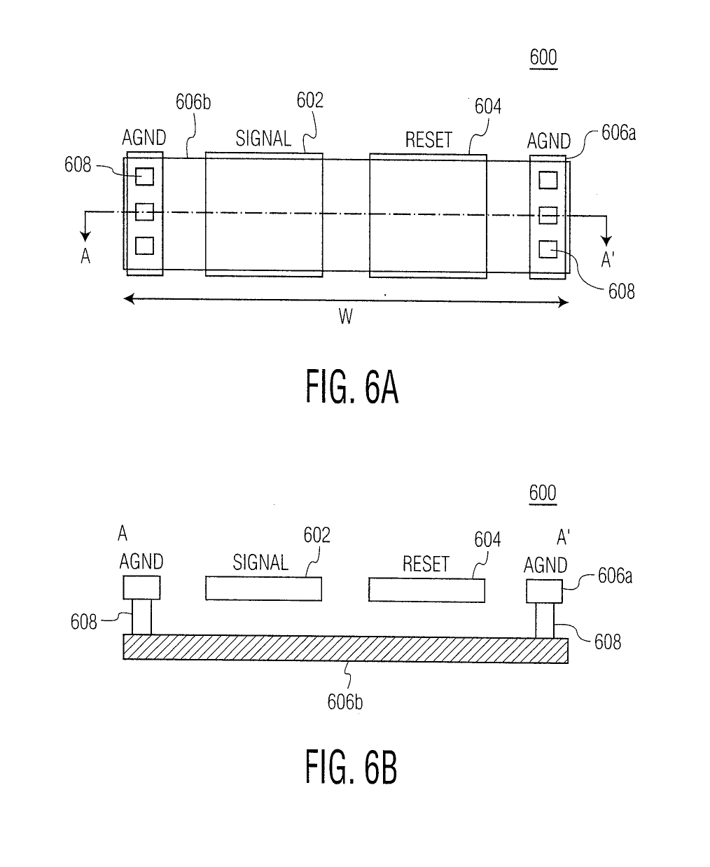

FIGS. 6A and 6B illustrate a portion of global bus configuration 600 where a reset bus 604 and a signal bus 602 are placed next to each other on one conductive layer. In particular FIG. 6A is an overhead view of a portion of global bus configuration 600 relative to the bus routing width (W); and FIG. 6B is a cross section taken along lines A-A′ of global bus configuration 600.

As shown in FIGS. 6A and 6B, global bus configuration 600 includes a ground bus 606a, signal bus 602 and reset bus 604 on one conductive layer, for example metal (M) M4. In addition, ground bus 606a is connected to ground bus 606b on a different conductive layer by via 608, for example M2. Signal bus 602 and reset bus 604 are typically placed on a top conductive layer typically having a lowest sheet resistance.

The configuration of signal bus 602 and reset bus 604 is similar to the conductors 306a,b or 308a,b global bus configuration illustrated in FIGS. 3A and 3B. As described above, global bus configuration 600 may receive an unequal interference from one or more EMI sources, thus causing an imbalance on the reset and image signals transmitted to amplifier circuits 212 (FIG. 2). If more than one channel is provided, a channel mismatch may occur. In addition, because the top conductive layer is used for routing signal bus 602 and reset bus 604, the EMI effect may become more pronounced for this top conductive layer configuration. Furthermore, the bus routing width (W) may occupy a large layout/chip area for a large number of differential pair architectures.

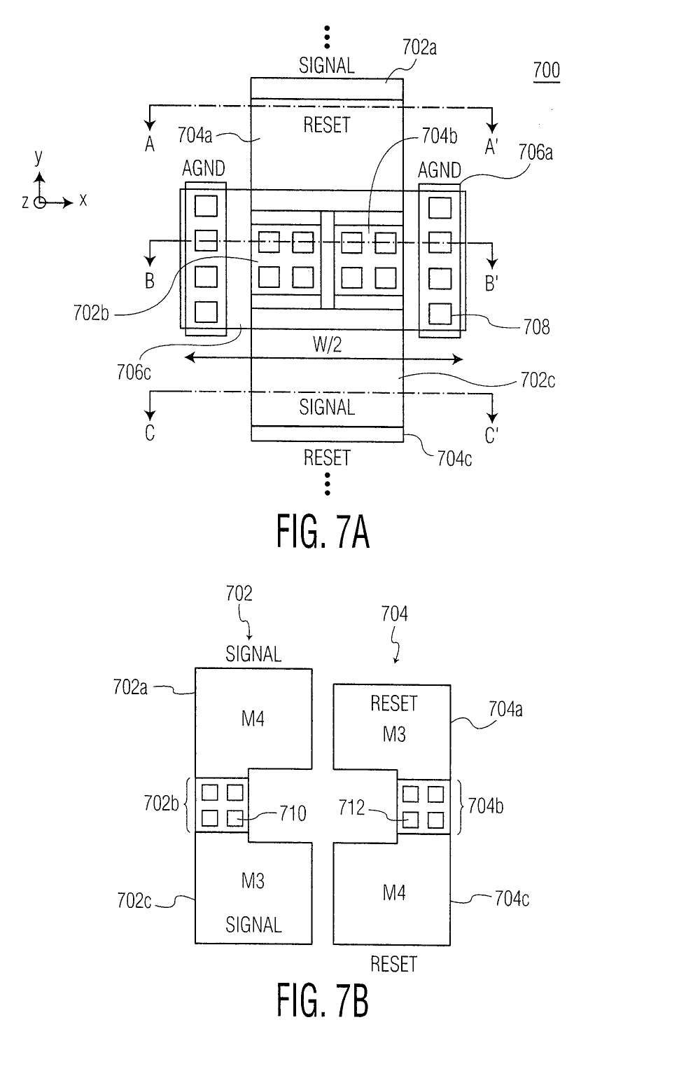

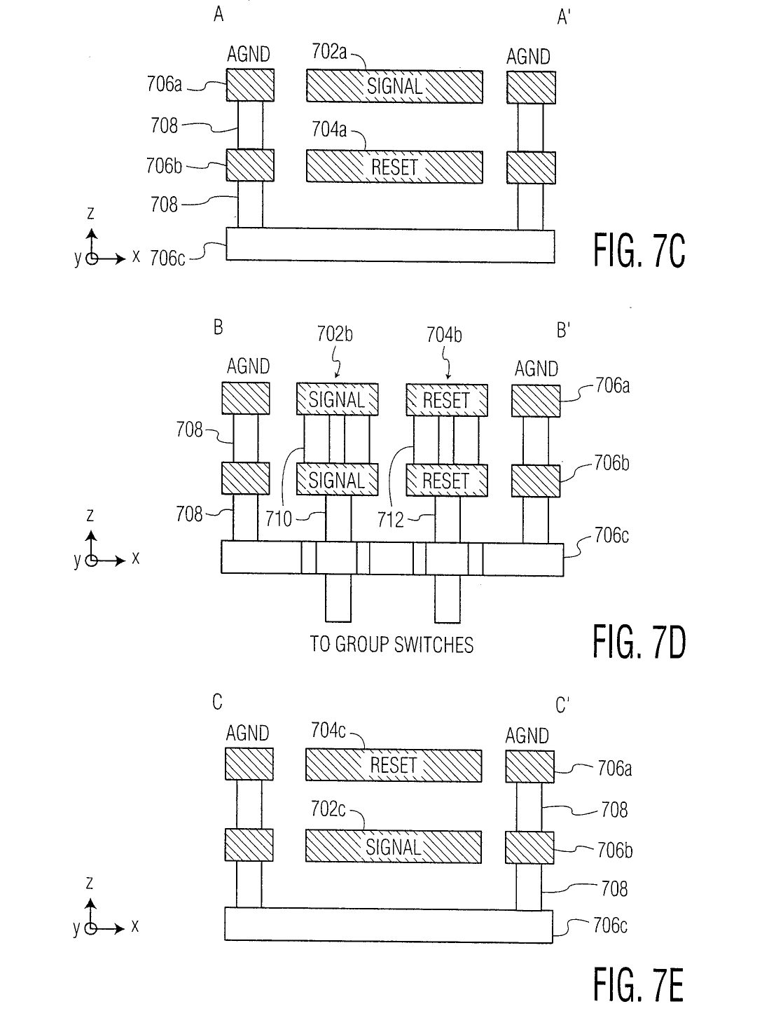

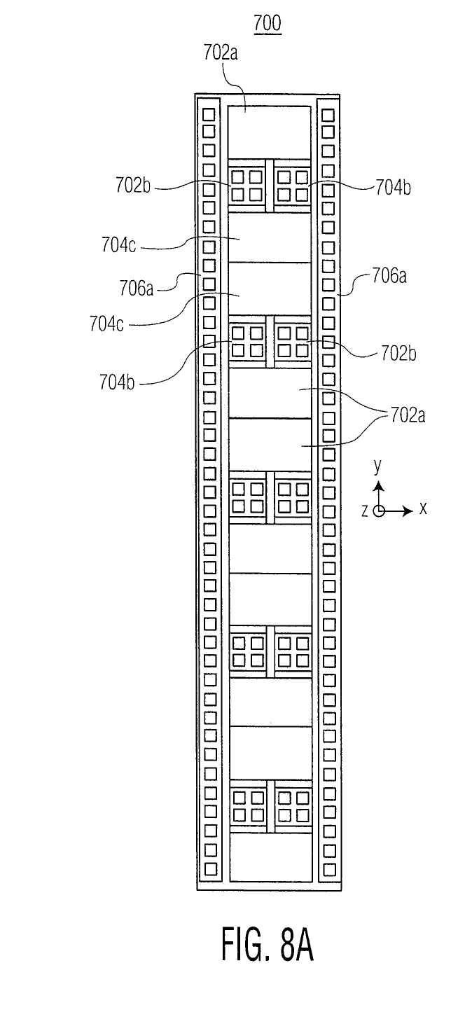

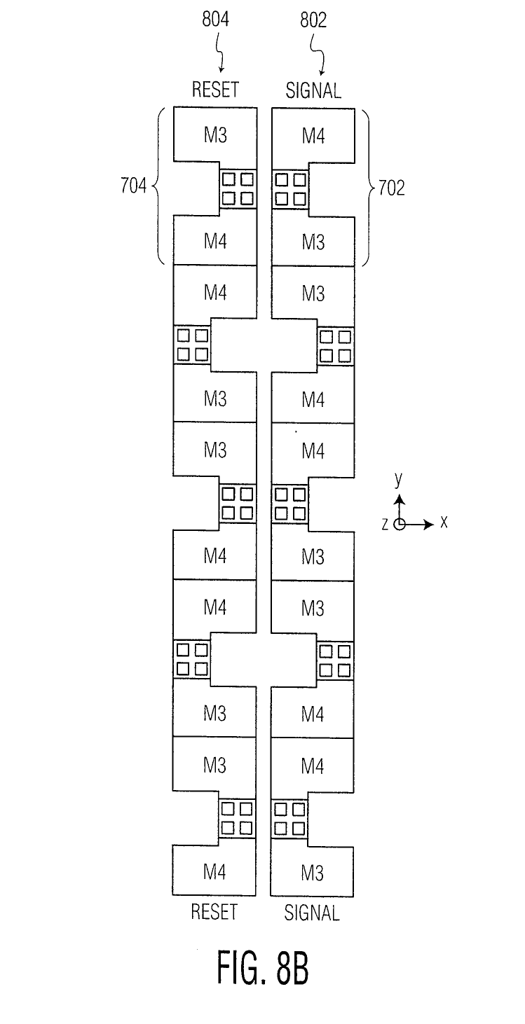

FIGS. 7A-7E, 8A and 8B illustrate a global bus configuration 700 according to an example embodiment of the present invention. In particular, FIG. 7A is an overhead view of a portion of global bus configuration 700 illustrating a bus routing width (W/2); FIG. 7B is an exploded overhead view of the portion of global bus configuration 700 shown in FIG. 7A; FIG. 7C is a cross section diagram of global bus configuration 700 along line A-A′; FIG. 7D is a cross section diagram of global bus configuration 700 along line B-B′; FIG. 7E is a cross section diagram of global bus configuration 700 along line C-C′; FIG. 8A is an overhead view illustrating a bus routing length of global bus configuration 700; and FIG. 8B is an exploded overhead view of global bus configuration 700 shown in FIG. 8A.

As shown in FIGS. 7A-7E, signal bus portion 702 and reset bus portion 704 are routed on alternate layers, for example, M3 and M4. Accordingly, signal bus portion 702 includes a segment 702a provided on M4 and a segment 702c provided on M3. Signal bus 702 also includes a via segment 702b having vias 710 connected to group switches (FIG. 7D). Similarly, reset bus portion 704 also includes a first segment 704a provided on M3 and a second segment 704c provided on M4. In addition, reset bus 704 includes via section 704b having vias 712 connected to group switches (FIG. 3D).

Each adjacent via section 702b, 704b (FIG. 7D) provide a twist (T) of the signal bus 802 and reset bus 804 (FIG. 8B). As shown in FIGS. 7C and 7E, signal bus 702 and reset bus 704 are provided in a twisted pair configuration relative to the Z-axis.

Global bus configuration 700 also includes ground bus 706 that is formed among the conductive layers, for example M2-M4, by ground bus conductors 706a-c coupled by vias 708. Although four vias 710, 712 for connection to the group switches and one via 708 for connection of ground bus layers 706a-c are shown, it is understood that any suitable number of vias 710, 712 may be used as long as a connection is ensured. A larger number of vias may minimize an impedance and/or provide additional connection between conductive layers.

As shown in FIGS. 8A and 8B, signal bus portion 702 is repeated along a length of global bus configuration 700 to produce signal bus 802. Similarly, reset bus portion 704 is repeated along a length of global bus configuration 700 to form reset bus 804. Via section 702b is used to connect section 702a and 702c of the alternating M3 and M4 layers. Similarly, via section 704b is used to connect reset section 704a and 704c on the alternating M3 and M4 layers along the length of global 700. In FIGS. 8A and 8B, five twists are formed by via sections 702b, 704b.

Although FIGS. 8A and 8B illustrates a global bus having 5 twists, for a typical pixel imager, for example, C25A(MI2030), a number of columns on each side is about 870. If 32 columns per group exist, a total of 27 groups select switches exist. In this example, signal bus 802 and reset bus 804 twist around each other at least 27 times for global bus configuration 700. It is understood that a number of twists could be increased or decreased according to the respective layout and design requirements.

Typically, global bus design and CMOS image sensors use two wide parallel metal layers to connect group signals to the amplifier 114 (FIG. 2), for example, as shown in FIG. 6A. Types, sizes, total heights of these buses as well as a twisted pair height (x dimension) and savings are shown in Table 1. In general, the inventors have determined that a height savings is typically larger than 40% of the original global bus height.

TABLE 1
Comparison of side by side and twisted global bus configurations

| | # of | | | Twisted | | |
|---|---|---|---|---|---|---|
| | Bus | Bus | Total Bus | Pair | | |
| | Pairs | Layer and | Height | Height | Savings | Savings |
| Design | (N) | Height (H) | (μm) | (μm) | (μm) | (%) |
| A | 4 | M4/2.75 | 36.25 | 21.25 | 15.0 | 41 |
| B | 2 | M4/2.75 | 17.11 | 9.61 | 7.5 | 44 |
| C | 2 | M4/2.75 | 21.11 | 12.61 | 9.5 | 45 |
| D | 1 | M4/1.50 | 9.24 | 5.74 | 3.5 | 38 |

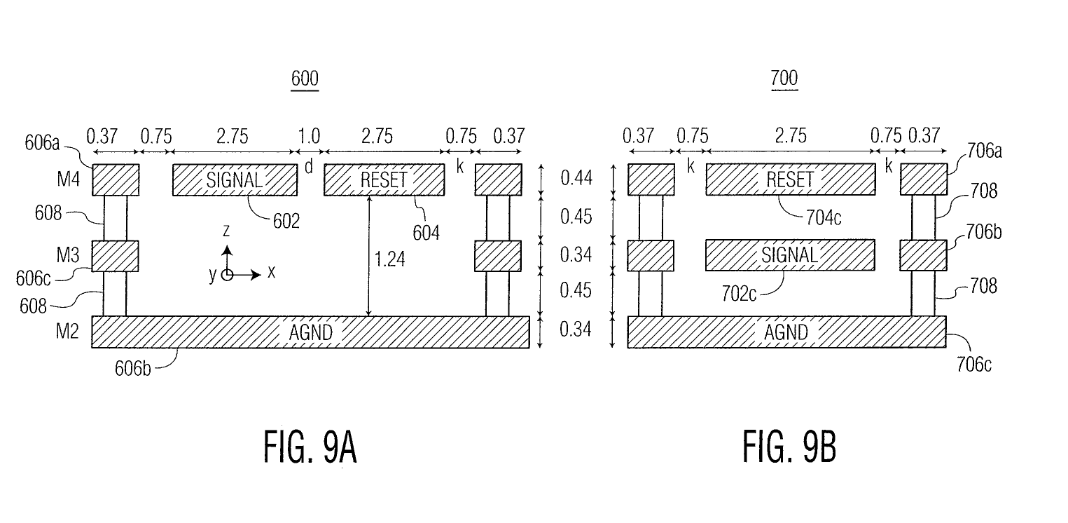

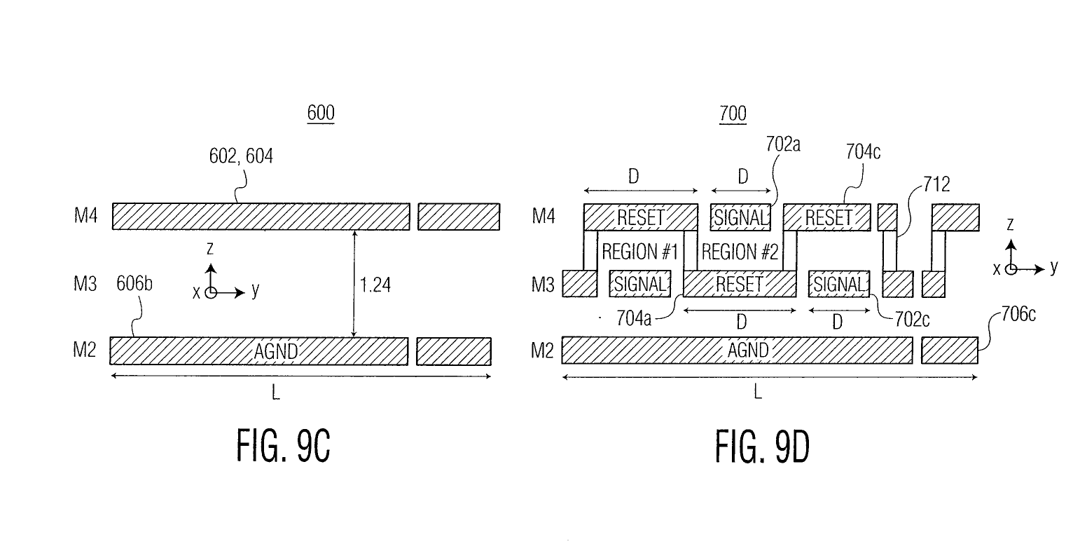

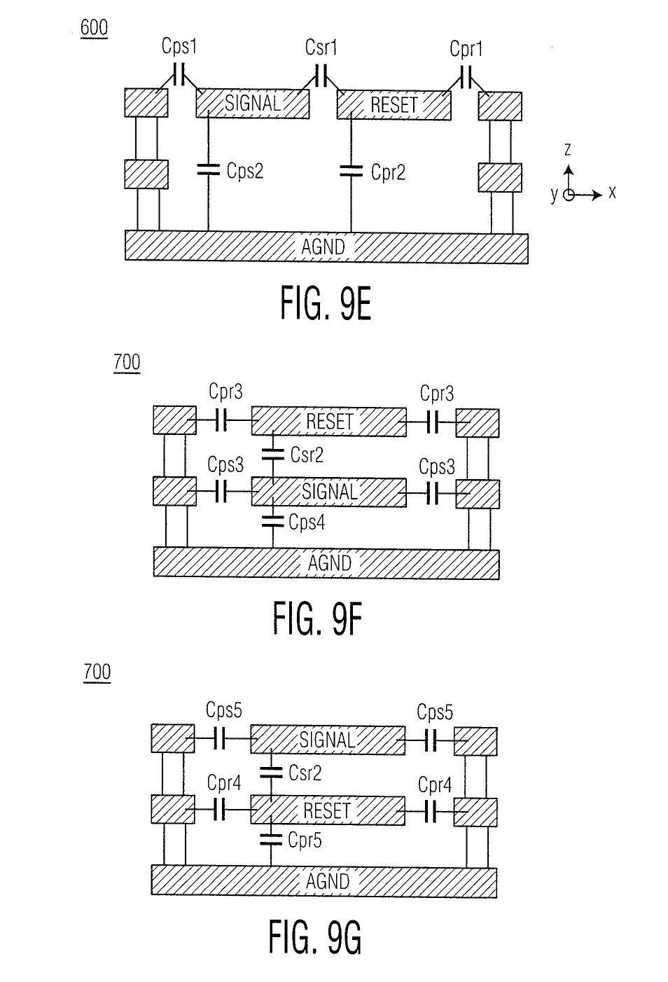

FIGS. 9A-9G illustrate examples of typical dimensions and parasitic capacitances for global bus configuration 600 (FIG. 6A) and global bus configuration 700 (FIG. 7A). In particular, FIG. 9A is a cross section diagram of global bus configuration 600 illustrating typical global bus dimensions relative to the bus routing width; FIG. 9B is a cross section diagram of global bus configuration 700 taken along line C-C′ (FIG. 7E) illustrating typical global bus dimensions relative to the global bus routing width; FIG. 9C is a cross section of global bus configuration 600 illustrating typical global bus dimensions relative to a global bus length (L); FIG. 9D is a cross section of a length of global bus configuration 700 illustrating twist segments (D) dimensions and a global bus length (L); FIG. 9E is a cross section of a width of global bus configuration 600 illustrating various parasitic capacitances coupled to the global bus; FIG. 9F is a cross section of global bus 700 taken along line an C-C′ (FIG. 7E) illustrating various parasitic capacitances coupled to the global bus; and FIG. 9G is a cross section of global bus configuration 700 taken along line an A-A′ (FIG. 7C) illustrating various parasitic capacitances coupled to the global bus.

Typically, for CMOS imagers, the number of twists (T) is about 27, a number of groups (G) is about 27, twist segments (D) are typically about 53.40 μm, bus length (L) is typically about 3045 μm, the spacing (d) between signal bus 602 and reset bus 604 (FIG. 9A) is typically about 1.00 μm and spacing k (FIGS. 9A and 9B), i.e. the spacing between ground bus 606a, 706a, and signal bus 602, 702 or reset bus 604, 704 is typically about 0.75 μm. The parasitic capacitances Cps, Cpr and Csr are described above.

An example of analysis of size and height savings by global bus configuration 700 as compared with global bus configuration 600 is described below, where the effects of the parasitic capacitances (FIGS. 9E-9G) are also considered.

For global bus configuration 600 (FIG. 9E):

Cps1=Cpr1=(L* 0.44*ε)/0.75=Cu,

Cps2=Cpr2=(L*2.75*ε)/1.24 =3.78*Cu, and

Csr1=(L*0.44*ε)/1.0=0.75*Cu.

For global bus configuration 700 (FIGS. 9F and 9G):

Cpr3=Cps5˜Cu,

Cps3=Cpr4=(L*0.34*ε)/0.75=0.77*Cu,

Cps4=Cpr5=(T*D*2.75*ε)*(L/L)/0.45=4.93*Cu, and

Csr2=(2*T*D*2.75*ε)*(L/L)/0.45=9.9*Cu,

where ε represents permittivity.

Let Cp(total, node_p)=Cp(total, node_n). Then for global bus configuration 600 (FIG. 9E), the total parasitic capacitance Cp1 becomes:

Cp1(total, node_{—}n)=Cps1+Cps2+2*Csr1, or

Cp1(total, node_{—}n)=Cu+3.78*Cu+2*0.75*Cu=6.28*Cu.

The total parasitic capacitance Cp2 for global bus configuration 700 (FIGS. 9F and 9G) becomes:

Cp2(total, node_{—}n)=2*Cps3+Cps4+2*Cps5+2*Csr2, or

Cp2(total, node_n)=2*0.77*Cu+4.93*Cu+2*Cu+2*9,9*Cu=18.37*Cu,

where node n and node p are shown in FIG. 3D. Accordingly, twisted pair global bus configuration 700 may be more susceptible to parasitic capacitances that may affect the ASC operation speed and power. However, global bus configuration 700 provides a smaller layout footprint, for example, about 45% smaller (based on the dimensions shown in FIGS. 9A and 9B). In addition, the twisted pair global bus configuration 700 may provide significant EMI immunity to differential signals that are transferred through a long global bus.

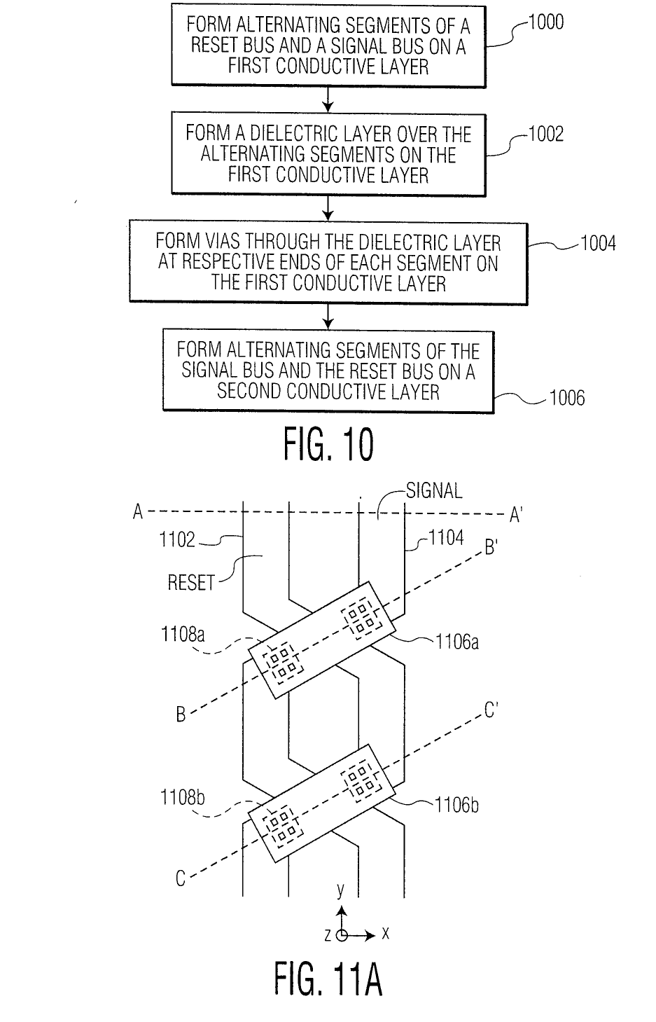

FIG. 10 is a flow chart illustrating a method of fabricating global bus configuration 700 (FIG. 8A), according to an embodiment of the present invention. In step 1000, alternating segments of reset bus 804 and signal bus 802 (FIG. 8B) are formed on a first conductive layer, for example, M3, along a bus routing length of global bus configuration 700. In step 1002, a dielectric layer is formed over the alternating segments on the first conductive layer.

hi step 1004, vias are formed through the dielectric layer at respective ends of each segment of the reset bus and signal bus on the first conductive layer, for example, to form via sections 702b and 704b, as shown in FIG. 8B. In step 1006, alternating segments of the signal bus 802 and reset bus 804 are formed on a second conductive layer, for example, M4.

The alternating segments on the second conductive layer are formed such that ends of each segment on the second conductive layer correspond to the ends of segments on the first conductive layer. The vias are formed to connect the corresponding segments of the reset bus on the first conductive layer to the segments of the reset bus on the second conductive layer. In addition, the vias are also formed to connect the corresponding segments of the signal bus on the first conductive layer to the segments of the signal bus on the second conductive layer. A twisted pair configuration of the reset bus and the signal bus are thus formed on two conductive layers.

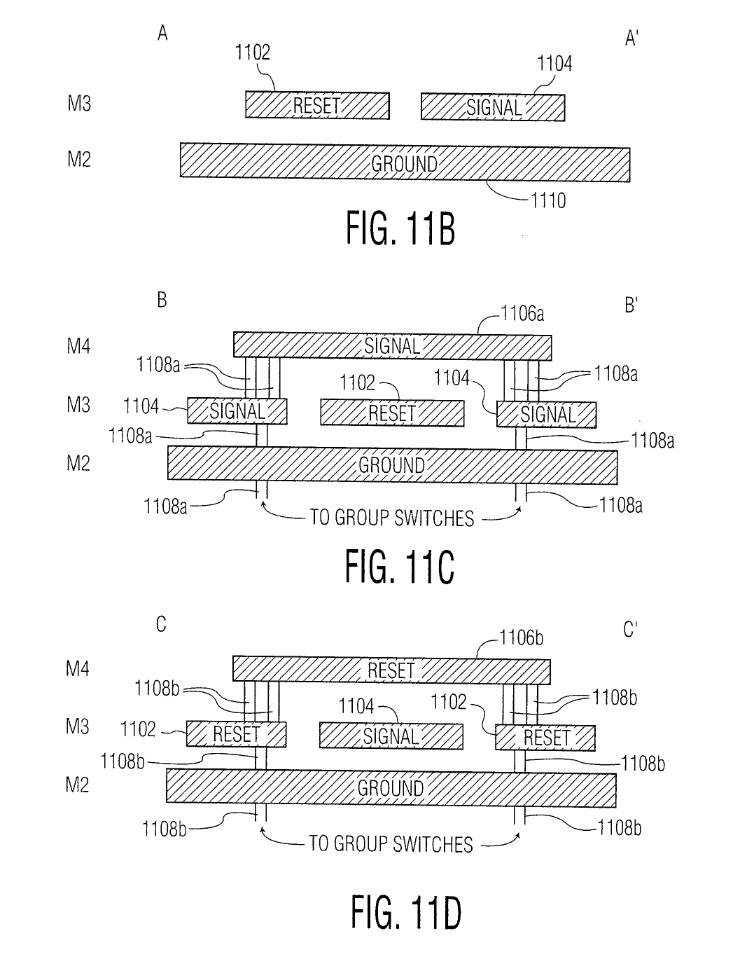

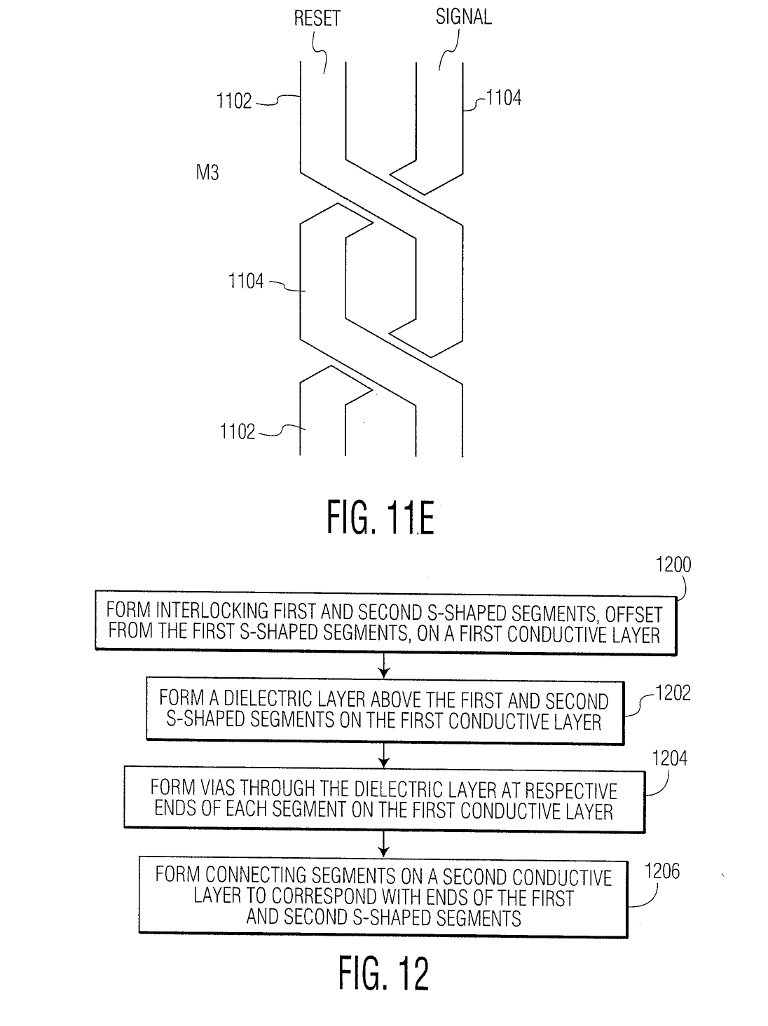

FIGS. 11A-11E illustrate a twisted pair global bus configuration 1100 according to another embodiment of the present invention. In particular, FIG. 11A is an overhead view of global bus configuration 1100; FIG. 11B is a cross section view of global bus configuration 1100 along line A-A′; FIG. 11C is a cross section view of global bus 1100 configuration along line B-B′; FIG. 11D is a cross section view of global bus configuration 1100 along line C-C′; and FIG. 11E is a plane view of global bus 1100 at conductive layer M3.

As shown in FIGS. 11A-11E, global bus 110 includes interlocking S-shaped reset segments 1102 and S-shaped signal segments 1104 that are both provided on one conductive layer, for example, M3. Connecting segments 1106A connect S-shaped signal segments 1104 and connecting segments 1106B connect S-shaped reset segments 1102. Connecting segments 1106A, 1106B are formed on another conductive layer, for example M4 and are connected to corresponding S-shaped reset segments 1102 and S-shaped signal segments 1104 by respective vias 1108a, 1108b. The S-shaped reset segments 1102 and signal segments 1104 are interconnected on one conductive layer such that they form a twisted pair (i.e. are interlocked).

Although four vias 1108 are shown between M3 and M4 and one via 1108 is shown between M2 and M3 in FIG. 11A, it is understood that any suitable number of vias 1108 may be provided according to, for example, impedance considerations. Ground bus 1110 is shown on conductive layer M2 to illustrate formation of global bus configuration 1100 on the conductive layers. Vias 1108a and 1108b may be used to connect S-shaped reset segments 1102 and S-shaped signal segments 1104 to corresponding group switches for selecting a row of pixel array 102 (FIG. 1).

FIG. 12 is a flowchart illustrating a method of forming global bus configuration 1100 (FIG. 11A-11E). In step 1200, first and second interlocking S-shaped segments of a reset bus and a signal bus are formed on a first conductive layer, for example, M3. The second S-shaped segments are formed adjacent to the first S shaped segments and offset from the first S shaped segments relative to the bus routing length of global bus 1100 (FIG. 11A). In step 1202, a dielectric layer is formed over the first and second S shaped segments on the first conductive layer. In step 1204, vias are formed through the dielectric layer at respective ends of each segment formed on the first conductive layer, for example, as shown in FIG. 11A.

In step 1206, connecting segments are formed on a second conductive layer, for example M4, such that ends of the connecting segments correspond to ends of the first and second S-shaped segments formed on the first layer. The vias are formed to connect the corresponding S-shaped segments of the reset bus and the corresponding S-shaped segments of the signal bus. Thus, a twisted pair global bus configuration 1100 is formed.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for reducing an interference signal from at least one electromagnetic interference (EMI) source, the method comprising:
forming first and second conductor lines on an integrated circuit in a twisted pair configuration; and
forming a differential amplifier on the integrated circuit, the differential amplifier coupled to each of the first and second conductor lines,
wherein first and second signals are respectively transmitted through the first and second conductor lines, each of the first and second signals being modified by the interference signal, and
the modified first and second signals are differentially amplified by the differential amplifier,
whereby the interference signal is substantially cancelled.

2. The method according to claim 1, the method further including:
forming first and second grounded conductors such that the first and second conductor lines are between the first and second grounded conductors.

3. The method according to claim 1, wherein the first and second signals include reset and image signals of an imager and the first and second conductors form a channel of a global bus.

4. The method according to claim 1, wherein the interference signal includes a further interference signal and the method further includes:
forming a third and fourth conductor lines on the integrated circuit in a further twisted pair configuration; and
forming a further differential amplifier on the integrated circuit, the further differential amplifier coupled to each of the third and fourth conductor lines,
wherein third and fourth signals are respectively transmitted through the third and fourth conductor lines, each of the first and second signals being modified by the further interference signal, and
the modified third and fourth signals are differentially amplified by the further differential amplifier.

5. The method according to claim 4, wherein the first and second signals include first reset and image signals of an imager, the first and second conductors form a first channel of a global bus, the third and fourth signals include second reset and image signals of the imager and the third and fourth conductors form a second channel of the global bus.

6. A method for reducing an interference signal from at least one electromagnetic interference (EMI) source, the method comprising:
forming a first conductor line and a first grounded conductor line on an integrated circuit in a first twisted pair configuration;
forming a second conductor line and a second grounded conductor line on the integrated circuit in a second twisted pair configuration; and
forming a differential amplifier on the integrated circuit, the differential amplifier coupled to each of the first conductor line and the second conductor line,
wherein first and second signals are respectively transmitted through the first conductor line and the second conductor line and
the first grounded conductor line and the second grounded conductor line are terminated ground connections, and are differentially amplified by the differential amplifier,
whereby the first and second signals are substantially shielded from the interference signal.

7. The method according to claim 6, wherein the first and second signals include reset and image signals of an imager and the first and second conductors form a channel of a global bus.

8. A method for fabricating a global bus of an imager, the global bus having a first conductor and a second conductor, the method comprising:
forming alternating segments of the first conductor and the second conductor on a first conductive layer;
forming a dielectric layer above the alternating segments of the first conductor and the second conductor;
forming vias through the dielectric layer at respective ends of each segment on the first conductive layer; and
forming further alternating segments of the second conductor and the first conductor on a second conductive layer above the dielectric layer such that ends of each further segment on the second conductive layer correspond to the ends of the segments on the first conductive layer,
wherein the vias are formed 1) to connect the corresponding segments of the first conductor on the first conductive layer to the further segments of the first conductor on the second conductive layer and 2) to connect the corresponding segments of the second conductor on the first conductive layer to the further segments of the second conductor on the second conductive layer.

9. The method according to claim 8, the method further including:
forming first and second grounded conductors such that the first and second conductors are each between the first and second grounded conductors.

10. The method according to claim 8, wherein the global bus is fabricated by a semiconductor process having at least four metal layers.

11. The method according to claim 10, wherein the first conductive layer includes metal 3 (M3) and the second conductive layer includes metal 4 (M4).

12. The method according to claim 8, wherein:
the vias include first and second adjacent vias,
the first vias are formed to connect the corresponding segments of the first conductor on the first conductive layer to the further segments of the first conductor on the second conductive layer, and
the second vias are formed to connect the corresponding segments of the second conductor on the first conductive layer to the further segments of the second conductor on the second conductive layer.

13. The method according to claim 12, further include the step of connecting the first and second adjacent vias to corresponding group switches of the imager.

14. A method for fabricating a global bus of an imager, the global bus including a first conductor and a second conductor, the method comprising:
forming interlocking first and second S-shaped segments of the first conductor and the second conductor, respectively, on a first conductor layer, the second S-shaped segments adjacent and offset from the first S-shaped segments;
forming a dielectric layer above the interlocking first and second S-shaped segments;
forming vias through the dielectric layer at respective ends of each of the first S-shaped segments and the second S-shaped segments on the first conductive layer; and
forming connecting segments on a second conductive layer such that ends of the connecting segments correspond to the ends of each of the first S-shaped segments and the second S-shaped segments on the first conductive layer,
wherein the vias are formed to connect the first S-shaped segments to define a first bus and the vias are formed to connect the second S-shaped segments to define a second bus.

15. The method according to claim 14, wherein the global bus is fabricated by a semiconductor process having at least four metal layers.

16. The method according to claim 15, wherein the first conductive layer includes metal 3 (M3) and the second conductive layer includes metal 4 (M4).

17. The method according to claim 14, wherein:
the vias include first and second alternating vias relative to a length of the global bus,
the first vias are formed to connect the first S-shaped segments, and
the second vias are formed to connect the second S-shaped segments.

18. The method according to claim 17, wherein the first and second alternating vias are connected to corresponding group switches of the imager.

19. An imager comprising:
a pixel array comprising a plurality of pixels arranged in a plurality of rows and a plurality of columns;
sample and hold (S/H) circuitry configured to read and store reset and image signals from the pixel array corresponding to a selected row and column of the pixel array;
a global bus, including first and second conductors, configured to respectively transmit the reset and image signals, the first and second conductors forming a twisted pair configuration; and
a differential amplifier circuit configured to differentially amplify the reset and image signals received from the global bus.

20. The imager according to claim 19, wherein the reset and image signals transmitted through the respective first and second conductors are each modified by an interference signal and the differential amplifier circuit includes a common mode rejection to substantially cancel the interference signal.

21. The imager according to claim 19, wherein the first and second conductors define a first channel, the S/H circuitry is configured to read and store further reset and image signals from the pixel array, and the global bus includes third and fourth conductors configured to respectively transmit further reset and image signals, the third and fourth conductors forming a twisted pair configuration and defining a second channel.

22. The imager according to claim 21, wherein the differential amplifier circuit is configured to differentially amplify the further reset and image signals received from the second channel of the global bus.

23. The imager according to claim 19, wherein the first and second conductors are formed among alternating conductive layers and include vias to connect the corresponding first and second conductors among the alternating conductive layers.

24. The imager according to claim 23, wherein the imager includes group switches configured to select the corresponding row and column of the pixel array, and the vias connect to the respective group switches.
